(19) United States
(12) Patent Application Publication
(10) Pub. No.: US 2002/0059640 A1
(43) Pub. Date: May 16, 2002

(54) Interactive advertising/entertainment system

(76) Inventor: Kambiz Rafizadeh, West Vancouver (CA)

Correspondence Address: Diane Dunn McKay, Esq., Mathews, Collins, Shepherd & Gould, P.A., Suite 306, 100 Thanet Circle, Princeton, NJ, 08540, US

(21) Appl. No.: 09/825,389

(22) Filed: Apr. 2, 2001

(30) Foreign Application Priority Data
Sep. 8, 2000 (CA) 2,317,869

(51) Int. Cl. H04N 7/025; H04N 7/10; H04N 7/16; G06F 3/00; G06F 13/00; H04N 5/445

(52) U.S. Cl. 725/135; 725/34; 725/37

(57) ABSTRACT

An advertising/entertainment system is provided including a media presentation having an interactive response system, the interactive response system for presenting response choices to users based on the subject matter of the media presentation and for receiving user responses for developing further media presentations based on the user responses. The system encourages a user to become a member of the system, disseminate information about products to users and encourage users to participate in a story in which the users determine the progress of the story's plot-line while reviewing advertisements.

### FIELD OF THE INVENTION

An advertising/entertainment system is provided including a media presentation having an interactive response system, the interactive response system for presenting response choices to users based on the subject matter of the media presentation and for receiving user responses for developing further media presentations based on the user responses. The system encourages a user to become a member of the system, disseminate information about products to users and encourage users to participate in a story in which the users determine the progress of the story's plot-line while reviewing advertisements.

### BACKGROUND OF THE INVENTION

The continued growth of the internet is providing unique e-business opportunities for business-to-business and business-to-consumer transactions. The opportunities provided by the internet for sellers to advertise and access consumers interested in their products and services are unparalleled in history in terms of scope. Primarily, these opportunities include the potential for market penetration resulting from the relatively low costs associated with operating and maintaining web-site based advertisements and the overall growth in internet usage.

As a result of the relative youth of the internet, the development and deployment of sophisticated and effective seller/consumer interactions over the internet has yet to be developed. In particular, while the web has, to a limited extent, enhanced the ability for advertisers to develop larger markets for their products and services, they have not been able to encourage consumers to make multiple and repeat visits to specific websites. That is, there has been a need for systems which encourage users to return to the same website in a manner which benefits both an advertiser and the user.

A user may visit a website for a variety of reasons including knowledge information, product or service information or for entertainment and, in particular, interactive entertainment. In order to enhance the value of advertising, there has been a need to combine effective advertising with interactive entertainment, such that from the user's perspective, a primary objective of receiving entertainment is realized while directly or indirectly receiving advertising information.

Thus, there has been a need for a system which provides both a media presentation to a user and interactive response system which allows users to direct further development of the media presentation and which combines effective advertising messages either within the media presentation or associated with the media presentation.

Past systems, have to a limited extent, provided an interactive media presentation to a user with an interactive response system. However, past systems have not provided effective advertising within or associated with the presentation.

### SUMMARY OF THE INVENTION

In accordance with the invention, there is provided an entertainment and advertising system comprising:

a media presentation, the multi-media presentation including:

a story module for presenting an episode of a story;

an advertising module including at least one link to advertisements of respective advertisers; and

an interactive response module operatively linked to the story module,

wherein an episode of the story requests user input to determine the content of a next episode of the story through a series of questions presented by the interactive response module and wherein the episode invites user research of the advertising module and the interactive response module requires use of the advertising module prior to enabling user input to the interactive response module.

In further embodiments, the media presentation includes a membership module for registering a user with the system and the interactive response module requires user registration prior to enabling user input to the interactive response module and/or the media presentation is selected from any one of or a combination of a multi-media website presentation, a radio presentation, a television presentation or a print media presentation.

In a still further embodiment, the media presentation is operatively connected to a management module for receiving and reporting specific user information to at least one advertiser.

In yet another embodiment, the interactive response system includes a media development module operatively connected to the media presentation, the media development module for receiving user responses and developing further media presentations based on the user responses.

In a more specific embodiment, an internet entertainment and advertising system is provided comprising:

a multi-media presentation on a website, the multi-media presentation including:

a story module for presenting an episode of a story;

an advertising module including a plurality of links to advertisements of respective advertisers; and

an interactive response module operatively linked to the story module,

wherein an episode of the story requests user input to determine the content of a next episode of the story through a series of questions presented by the interactive response module and wherein the episode invites user research of the advertising module and the interactive response module requires use of the advertising module prior to enabling user input to the interactive response module.

In further embodiments, the multi-media presentation includes a membership module for registering a user with the system and the interactive response module requires user registration prior to enabling user input to the interactive response module.

In yet further embodiments, the system includes a developer's module for developing further episodes wherein the interactive response module tabulates the users' selections for reporting to the developers module and/or a management module for tabulating user's use of the advertisement module for reporting to the advertisers.

In another embodiment, a method of encouraging user interaction with a website is provided comprising the steps of:

a. providing a multi-media presentation on a website, the multi-media presentation including:

a story module for presenting an episode of a story;

an advertising module including a plurality of links to advertisements of respective advertisers; and

an interactive response module operatively linked to the story module; and,

b. requesting user input to determine the content of a next episode of the story through a series of questions presented by the interactive response module and wherein the episode invites user research of the advertising module and the interactive response module requires use of the advertising module prior to enabling user input to the interactive response module.

In yet another embodiment, a method of advertising is provided comprising the steps of:

a. presenting a media presentation including product/service specific information to at least one user;

b. presenting response choices to users based on the subject matter of the media presentation;

c. receiving user responses to the response choices; and

d. developing further media presentations based on the user responses.

### BRIEF DESCRIPTION OF THE DRAWINGS

FIG. 1 is an overview of the operation of the interactive advertising/entertainment system in accordance with the invention.

### DETAILED DESCRIPTION OF THE INVENTION

System Overview

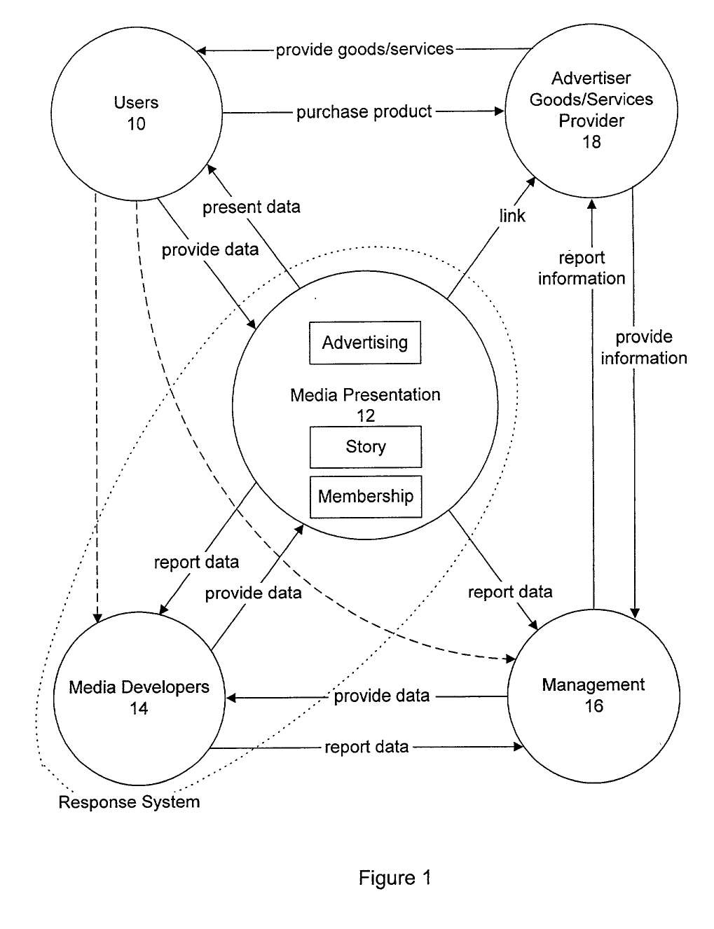

With reference to FIG. 1, a system is provided which enables the interaction between users 10, a media presentation 12, media developers 14, management 16 and advertisers and/or goods and services providers 18 to exchange information for commercial and entertainment purposes.

More specifically, the invention relates to a system and method for encouraging user interaction with a media presentation, primarily for disseminating product information to users and collecting consumer data but also to provide entertainment to a user.

As an overview, a user 10 can obtain information from a media presentation 12 and based on the information presented, the user 10 can provide data to the media developers 14 and/or management 16. The media 12 is updated by the media developers 14 based on the data from the users 10 and from management 16. Management 16 receives data from the media developers, from the media and advertisers as well as providing data to the media developers 14 and the advertisers 18. The advertisers receive data from management and purchase requests from users and provide goods/services to users 10.

The system and method includes a number of modules which:

1. Encourage and enable a user to become a member of the system;

2. Disseminate information about products and/or services to users;

3. Allows users to purchase products and/or services;

4. Encourage users to participate in a story in which the users determine the progress of the story's plot-line in order to:

a) encourage return visits to the system

b) collect consumer data from the users based on their interaction with the media for reporting to advertisers and for the evolution of the media.

Implementation

In a preferred embodiment, the system is implemented as a website and the media presentation is a computer audio/video presentation. However, it is envisaged that other media presentations may be implemented including print, radio, telephone and television or a combination thereof. In the context of a website, the media, media developers and management may be a server connected to the internet.

In the context of television, radio or print media, a media presentation may be presented by television or radio show or printed magazine, book, newspaper etc. and a user provides data to the media developers via telephone or internet.

System Modules

The system will preferably include the following modules operatively connected to one another to achieve the described functionality of the invention. The system is described in accordance with the preferred implementation on a website:

1. Presentations Module

The presentations module allows users to review episodes of a presentation depicting an evolving story-line. That is, the presentation will be updated regularly allowing new episodes of the story to be reviewed from the website. Each episode will be developed on the basis of information received from users on a previous episode.

For example, a presentation may include a number of story episodes developed around the lives of a number of characters such as a family, a group of people or other fictional characters. The characters may be given personalities appealing to a wide audience or to a more specific target audience. That is, the characters of the presentation may be portrayed with ordinary or unique characteristics with respect to their culture, appearance, names, intelligence, careers and their interaction with other members of the group as can be written by story-line developers.

Within each episode, the characters will be presented with situations from which they will seek guidance from the users 10 as to what decision they should make. In order for a user to assist in the decision, the presentation module presents a plurality of choices to the users from which an individual user may select their recommended choice. The decision selections of the users are used to develop a further episode of the story. The plurality of choices are presented by an interactive response module which, in different embodiments, will accept responses only if the advertising module and/or the membership module has been accessed.

Presentations Module

| Function | Medium | Data Format | Additional Information/Options |
|---|---|---|---|
| Display Story/Response | Website | Electronic multi-media | Response options displayed as multiple choice selections |
| Options | | | |
| | Print | Print media | Response options displayed as written questionaire with |
| | | | multiple choice selections |
| | Radio | Audio with response | Response options oral list or direction to other media |
| | | options | including website or phone |
| | Television | Audio/video with | response options visual list or direction to other |
| | | response options | media including website or phone |
| Display Advertising | Website | electronic multi-media | optional link to advertiser website |
| | Print | print | contact information selected from website/telephone |
| | | | number/address information |
| | Radio | audio | contact information selected from website/telephone |
| | | | number/address information |
| | Television | audio/video | contact information selected from with website/telephone |
| | | | number/address information |
| Display Membership | Website | Electronic Website | user enters requested information into questionaire fields |
| Enrollment Information | | Data Questionaire | |
| | Print | Print Data | user may be directed to website/phone questionaire |
| | | Questionaire | |
| | Radio | direction to website/ | |
| | | phone questionaire | |
| | Television | direction to website/ | |
| | | phone questionaire | |

2. Membership Module

The membership module provides information about membership and allows users to register with the system. Membership, in a preferred embodiment, allows a user to provide a response to a presentation episode and allows management to collect/obtain specific user/consumer information. Preferably, the membership module obtains user information including, name and contact information as well as consumer profile information including age, profession, marital status, income, and interests.

Membership data is reported to management for processing and distribution if desired.

Membership Module

| Function | Medium | Data Format | Other information/options |
|---|---|---|---|
| Provide Membership | All Media | audio/video/print information | explains how membership works and |
| Information | | | its benefits |
| Present/Receive | Website | electronic website questionaire | |
| Membership Information | | questionaire | |
| | Print | printed instructions directing | printed questionaire for mailing/faxing |
| | | user to website or telephone | |
| | | questionaire | |
| | Radio, television | audio and/or video instructions | |
| | | directing user to website or | |
| | | telephone questionaire | |

3. Advertising Module

The advertising module presents advertising information to users as audio, video or print or a combination thereof. When implemented on a website, the advertising module may provide a direct link to the advertiser or their advertisements. In a preferred embodiment, a user will only be able to provide a response through the interactive response system if advertisements have been accessed.

Advertising Module

| Function | Media | Data Format | Other information/options |
|---|---|---|---|
| Present | Website | electronic | optional link to advertiser |
| Advertising | | multi-media | website |
| | print | print | optional contact information |
| | radio | audio | optional contact information |
| | television | audio/video | optional contact information |

4. Developer Module

The developer module allows developers to update the media presentation. More specifically, the developer module will receive data with respect to the choices made by users about a previous episode as well as advertising data from management. The developer module may also report presentation status.

Developer Module

| | | | Additional |
|---|---|---|---|
| Function | Media | Data Format | Information/options |
| Receive and process | Website | electronic | user responses received |
| user input data | | | and tabulated |
| Receive and process | Website | electronic | advertising data received |
| advertising data | | | and uploaded to website |
| Report presentation | Website | electronic | website status reported |
| status | | | to management |
| Update presentation | Website | electronic | website updated |

5. Management Module

The management module coordinates the operation of the system. In particular, the management module receives data from the advertisers and provides data to the developers and advertisers. Management may also receive data from the media presentation or from the users.

Management Module

| | | | Additional |
|---|---|---|---|
| Function | Media | Data Format | Information/options |
| Receive usage data | website | electronic | usage data tabulated for |
| | | | reporting |
| Receive membership/ | website | electronic | membership/consumer |
| consumer data | | | data tabulated for |
| | | | reporting |
| Receive website status | website | electronic | status of website |
| data | | | including story episode |
| | | | information, operability |
| receive advertising | website | electronic | advertisements received |
| data | | | from advertisers |
| provide advertising | website | electronic | advertisements forwarded |
| information | | | to developers |
| report usage/member- | website | electronic | tabulated data forwarded |
| ship/consumer data | | | to advertisers |

6. Advertiser Module

The advertisers provide advertising information to management for implementation on the system. In addition, advertisers receive information with respect to the usage, membership and consumer data.

Advertiser Module

| | | Implemen- | Additional |
|---|---|---|---|
| Function | Media | tation | Information/Options |
| provide advertisement | website | electronic | formatted advertisements |
| data | | | forwarded to management |
| receive usage/member- | website | electronic | formatted data received |
| ship/consumer data | | | from management |

### PRESENTATION EXAMPLE

In one embodiment, an episode of a story is presented on a website, with the characters of the story discussing various issues relevant to their lives. The story may discuss various products or services that the advertisers wish to have promoted. Access to specific advertisements may be provided as separate links from the presentation. Such links may be continuously active or become active only upon the completion of the episode of the story. At the completion of the episode, the user is prompted to select one or more options presented by the interactive response module. Prior to the entry of user selections, the system requires that at least one of the advertisements has been accessed before permitting entry of a user selection.

In another embodiment, the system also requires a user to register with the system before permitting entry of a user selection in the interactive response module.

Example Characters:

In a creating a presentation, characters having any variety of qualities or characteristics may be developed. For example, these characters may be defined as a family with characteristics appealing to a wider audience:

| | | Personal | Purchasing |
|---|---|---|---|
| Character | Age/Career | Characteristics | Characteristics |
| Adult Male | 35-40/Profes- | Balance between | enjoys technology |
| | sional | career and family | if it doesn't |
| | | | complicate life |
| Adult Female | 30-35/Home- | Priority to family | enjoys products |
| | maker | | which improve |
| | | | family life |
| Child Male | 36684 | Enjoys sports | all sports products |
| Child Female | 36747 | Enjoys drama | all collectables |

### EXAMPLE EVOLUTION OF EPISODES

The following is an example of the evolutionary process of episodes within the presentation:

1. In episode one, the family is planning a holiday. The episode may have a number of plot development and humorous exchanges about where and why they should take a holiday. The family creates a short list and asks the members where they should go.

2. The majority of members vote that the family should holiday in Hawaii.

3. In episode two, the family determines that they do not have enough money to go to Hawaii and, they ask the audience whether they should compromise the destination or search online for a better deal.

4. The majority of viewers vote that the family should search online.

5. In episode three, the family finds a package they can afford. Now, they need a new camera (or other product) and ask for help.

6. The audience votes for a specific camera.

7. In episode four, the family is in Hawaii and needs something . . .

As is understood, a large number of situations can be presented to the characters and the story-line can evolve accordingly. During evolution of the story, specific consumer survey data is collected from the voting undertaken by the audience and can be reported to advertisers.

1. An entertainment and advertising system comprising:
a media presentation, the multi-media presentation including:
a story module for presenting an episode of a story;
an advertising module including at least one link to advertisements of respective advertisers; and
an interactive response module operatively linked to the story module,
wherein an episode of the story requests user input to determine the content of a next episode of the story through a series of questions presented by the interactive response module and wherein the episode invites user research of the advertising module and the interactive response module requires use of the advertising module prior to enabling user input to the interactive response module.

2. A system as in claim 1 wherein the media presentation includes a membership module for registering a user with the system and the interactive response module requires user registration prior to enabling user input to the interactive response module.

3. A system as in claim 1 wherein the media presentation is selected from any one of or a combination of a multi-media website presentation, a radio presentation, a television presentation or a print media presentation.

4. A system as in claim 1 wherein the media presentation is operatively connected to a management module for receiving and reporting specific user information to at least one advertiser.

5. A system as in claim 1 wherein the interactive response system includes a media development module operatively connected to the media presentation, the media development module for receiving user responses and developing further media presentations based on the user responses.

6. An internet entertainment and advertising system comprising:
a multi-media presentation on a website, the multi-media presentation including:
a story module for presenting an episode of a story;
an advertising module including a plurality of links to advertisements of respective advertisers; and
an interactive response module operatively linked to the story module,
wherein an episode of the story requests user input to determine the content of a next episode of the story through a series of questions presented by the interactive response module and wherein the episode invites user research of the advertising module and the interactive response module requires use of the advertising module prior to enabling user input to the interactive response module.

7. A system as in claim 6 wherein the multi-media presentation includes a membership module for registering a user with the system and the interactive response module requires user registration prior to enabling user input to the interactive response module.

8. A system as in claim 6 wherein the system includes a developer's module for developing further episodes and wherein the interactive response module tabulates the users' selections for reporting to the developers module

9. A system as in claim 6 wherein the system includes a management module for tabulating user's use of the advertisement module for reporting to the advertisers.

10. A method of encouraging user interaction with a website comprising the steps of:
a. providing a multi-media presentation on a website, the multi-media presentation including:
a story module for presenting an episode of a story;
an advertising module including a plurality of links to advertisements of respective advertisers; and
an interactive response module operatively linked to the story module; and,
b. requesting user input to determine the content of a next episode of the story through a series of questions presented by the interactive response module wherein the episode invites user research of the advertising module and the interactive response module requires use of the advertising module prior to enabling user input to the interactive response module.

11. A method as in claim 10 further comprising, prior to step (b), determining membership status of a user and prohibiting step (b) if the user is not a member.

12. A method as in claim 11 further comprising prior to step (b), determining membership status of a user and obtaining user data so as to activate membership of a user.

13. A method of advertising comprising the steps of:
a. presenting a media presentation including product/service specific information to at least one user;
b. presenting response choices to users based on the subject matter of the media presentation;
c. receiving user responses to the response choices; and
d. developing further media presentations based on the user responses.

14. An advertising/entertainment system comprising:
a media presentation including an interactive response system, the interactive response system for presenting response choices to users based on the subject matter of the media presentation and for receiving user responses for developing further media presentations based on the user responses.

15. A system as in claim 14 wherein the media presentation includes a membership module for encouraging a user to register with the advertising system.

16. A system as in claim 15 wherein the interactive response system allows a user to provide response choices only if the user has registered with the advertising system.

17. A system as in claim 15 wherein the membership module includes a questionaire for obtaining specific user information.

18. A system as in claim 14 wherein the media presentation includes advertising media selected from any one of or a combination of a multi-media website presentation, a radio presentation, a television presentation or a print media presentation.

19. A system as in claim 14 wherein the media presentation is operatively connected to a management module for receiving and reporting specific user information to at least one advertiser.

20. A system as in claim 14 wherein the interactive response system includes a media development module operatively connected to the media presentation, the media development module for receiving user responses and developing further media presentations based on the user responses.
